(19) United States
(12) Patent Application Publication
(10) Pub. No.: US 2019/0071174 A1
(43) Pub. Date: Mar. 7, 2019

(54) VERTICAL TAKE OFF AND LANDING AIRCRAFT WITH FOUR TILTING WINGS AND ELECTRIC MOTORS

(71) Applicant: NAVIS S.R.L., MONTE SAN SAVINO (IT)

(72) Inventors: Mario Burigo, MONTE SAN SAVINO (IT); MARCO CELSO MATTEONI, TORINO (IT); GIANNI SANTARELLI, AREZZO (IT)

(21) Appl. No.: 16/081,049

(22) PCT Filed: Mar. 9, 2017
(86) PCT No.: PCT/IB2017/000252

§ 371 Date: Aug. 30, 2018

(30) Foreign Application Priority Data
Mar. 15, 2016 (IT) ITUA20161595

(51) Int. Cl. B64C 29/00; B64C 3/38; B64D 27/24; B64C 11/28; B64C 11/46

(52) U.S. Cl. CPC B64C 29/0033; B64C 3/385; B64D 27/24; B64C 11/28; B64C 2201/165; B64C 2201/042; B64C 2201/088; B64C 2201/108; B64C 11/46

(57) ABSTRACT

The present invention, in the field of aviation, is a Vertical Take-Off and Landing (VTOL) vehicle comprising fuselage, vertical tail, four tilting wings, electric generator which uses liquid fuel, rechargeable electric energy storage devices, sensors comprising air flow sensors and an actuation and feedback control system. The four tilting wings may rotate, independently one from the other and in a controlled way, around two axes parallel to the pitch axis, one of these axis is in front of the center of gravity of the vehicle and the other behind it. All the four wings provide positive lift during forward flight. There is at least one electric motor in each wing which drives at least one thrust generator. The thrust generators wind streams interact with all the vehicle lifting wings during vertical take off and landing to reduce the possibility to stall at low vehicle speed. The thrust generators may provide a combined thrust higher than the aircraft weight; the power required to drive the electric motors comes from the electric generator and the additional power required to provide a thrust higher than the aircraft weight comes from rechargeable electric energy storage devices such as batteries or supercapacitors. An active feedback system allows to control the rotational speed of each thrust generators and the tilt angles of each wing and the rudder on the basis of given flight inputs such as aircraft direction and speed.

### STATE OF THE ART

A limit of the airplanes, whether they are manned or Unmanned Aerial Vehicle (UAV), is the need of a long runway for take off and land. Many decades ago Sikorsky indicated seven technical problems that limited the development of Vertical Take Off and Landing (VTOL) vehicle. Since then many different ideas have been proposed for VTOL vehicle. Among the so many proposals the majority have never left the design phase; problems with power, aerodynamics, mechanics and economics have stopped these ideas. Only few have actually materialized and in any case this type of vehicle has not spread as hoped.

The only successful VTOL vehicle is the helicopter which has excellent characteristics for vertical take off, landing and hovering but these capabilities comes at a price of mechanical complexity, lower speed and modest aerodynamic efficiency for cruise vrt airplanes.

More than one century ago the Sperry brothers demonstrated the first successful autopilot capable of maintaining aircraft pitch, roll and heading angles. Since then automatic control systems have become more and more advanced and important. They are used to monitor and control many of the aircraft subsystems and can be used to provide artificial stability, improve the flying qualities and to aid in the navigation of the aircraft. In the late 2000s, advances in electronics allowed the production of cheap lightweight flight controllers, accelerometers, Inertial Measurement Unit (IMU) and global positioning system. This led to the development and rapid proliferation of unmanned, small size, quadcopter along with other mufti rotor designs, bringing in cheap control of unstable configurations. Like helicopters, the quadcopter have good VTOL characteristics but low speed and modest aerodynamic efficiency for cruise vrt airplanes.

An effort to combine VTOL advantage of quadcopter or multi rotors with cruise efficiency of airplanes has been recently done in the UAV sector were few examples include Arcturus Jump, Quantum VRT and the electric Quad Tilt Wing developed by Chiba University and Japanese company GH Craft. Arcturus Jump 20 moreover uses an hybrid combination of electric motors for vertical take off and landing and endothermic engine for cruise and climb/descent.

These UAV are used in many sectors but their limitation is the payload they can carry.

The need for an aircraft that could combine the benefits of a vertical take off and landing capability with the high speed cruise of a fixed wing aircraft has led in the 50s' and 60s' to the evolution of tilt wing and tilt rotor concepts.

The tilt wing is basically a convertiplane concept. The wing can be tilted from its normal flight position with the propellers providing forward thrust, to a vertical position with the propellers providing vertical lift. However this potential capability, in those years, came at an even greater price than a conventional helicopter, including increased mechanical complexity, increased weight and aeroelastic problems. Several companies seriously considered the tilt wing concept but one or more of the problems anticipated by Sikorsky or other technical issues were never satisfactorily resolved with the technologies available at that time.

Of the several tilt rotor projects conceived since the 40s', including the Focke Achgelis 269, the Bell XV-15, Bell Boeing Quad TiltRotor and Augusta AH 609 only the Bell V-22 Osprey entered into production and only about 200 of them have been delivered in more than 30 years.

We believe that with the technology development achieved nowadays, the availability of Automatic Dependent Surveillance-Broadcast (ADS-B) for better air traffic control and the possibility to implement safe and reliable active feedback control to govern systems with various degrees of freedom it is possible to move forward with the four tilt wing/thrust configuration proposed in the present patent application, which is also suitable for UAV, and solve the problems which limited the development of VTOL vehicle in the general aviation market and turn the aircraft into a transportation system accessible to many more people.

### OBJECTS AND SUMMARY OF THE INVENTION

Aim of the present invention is to provide a four tilting wings vehicle which taking advantage of new, higher specific power, electric motors and batteries combined with the still higher energy density of endothermic liquid fuel engines and an all positive lift wings configuration, overcomes some drawbacks of the prior art.

In particular, aim of the present invention is to provide a vertical or almost vertical takeoff and landing aircraft with low realization costs and efficient cruise configuration. Furthermore this vehicle may also take off and land horizontally like a conventional aircraft.

These and other aims are reached by means of a vehicle which is provided with the features of the appended claims, which are integral part of the present description.

The basic idea of the present invention is to provide an aircraft that, in addition to a conventional fuselage and vertical tail, has four tilting wings, at least one electric motor in each wing which drives at least one thrust generator or rotor.

The four tilting wings can rotate with respect to the fuselage around two axes parallel to the pitch axis. One of this axes will be in front of the center of gravity of the aircraft and the other axis behind the center of gravity. Each of the two front wings may rotate, independently one from the other and in a controlled way, around the front axis and each of the two rear wings may rotate, independently one from the other and in a controlled way, around the rear axis.

The location of the tilt rotation axis on each wing depends on type of wing chosen, the expected variation of the center of pressure on each wing, the position of its center of mass and the wanted control torques on the tilt angles.

The rotors are arranged on the wings with their rotation axes along the direction of motion. The propeller disks extend beyond the wingtips so large parts of the wings are immersed in the propellers wind streams to reduce the possibility of stall at low speed.

The wings may have winglets, vortex generators, Leading Edge High Lift Device (LEHLD) and Trailing Edge High Lift Device (TEHLD), such as slats, flaps, ailerons or flaperon, for increased lift at lower speed or better control in pitch and roll.

Instead of a single vertical tail it is possible to have twin vertical tails mounted on the aft wings. These twin vertical tails may also be mounted downstream the aft wings thrusters in order to be more efficient at low translation speed.

The aircraft could either be a piloted aircraft or Unmanned Aerial vehicles (UAV).

The energy to the electric motors is provided by electric storage devices such as batteries or super capacitors and by generator/s. During the vertical take off, as well as during the vertical landing, it is required a power higher than the power needed for cruise or for horizontal take off. The power needed for cruise for this type of configurations is indeed less than 20% of the power required for vertical take off and landing.

The proposed aircraft exploits electric driven thrust generators suitably designed for providing great power to weight ratios. Currently multi phases BLDC (BrushLess Direct Current) electric motors have 5-15 kW/kg power density and there are high C rate batteries which may reach 30 kW/kg power density for short discharge times, much higher than the specific power of current endothermic engines. Moreover electric motors can be integrated more easily on tilting wings because they just need cables to feed and control them.

The vertical take off and landing, including contingency maneuvers, could take, for the proposed vehicle, no more than one minute and during these phases it is possible to draw the higher power required for the motors to produce the thrust from such batteries. Even if the power during vertical take off and landing is high, the short duration imply that the batteries need to accumulate a small amount of energy. The increased weight due to the electric motors and electric storage devices is quite modest and acceptable considering the added flexibility and VTOL capabilities.

A less powerful endothermic engine coupled to an electric generator is sufficient to generate the electric power needed to drive the electric motors to provide the thrust required for cruise and for recharging the storage device. This endothermic engine/generator can be installed within the fuselage in the most convenient part and feed the electric motors through proper cables. This hybrid combination is particularly advantageous because the liquid fuel have much higher energy density of any electric energy storage device currently available or envisaged and can provide much wider range. The best electric energy storage devices available nowadays have about 0.30 kWh/kg energy density while liquid fuel have energy density of about 12 kWh/kg, which, combined with the efficiency of existing endothermic engines, can provide about 4 kWh of energy per kg of fuel, much more than those provided by any existing electric storage device.

The weight of electric motors and thrust generators installed on each wing can be much lower than any other current alternative and this allows to keep mass, inertia, moments of inertia and angular momentum at low values, compatible with any fast change in the tilt angles which may be required by the control system.

The vertical thrust for vertical takeoff is achieved by tilting up the four wings and speeding up the rotors like in quadcopter. Attitude control for quadcopter is achieved by independent variation of the speed of each rotor; by changing the speed of each rotor it is possible to specifically generate the desired total thrust, to locate for the centre of thrust both laterally and longitudinally and to create a desired total torque, or turning force.

In our innovative aircraft, moreover, each wing, or part of it, interacts with air flows due to the rotors, the movement of the vehicle, the wind and eventually the down wash from the other wings and each wing has its own weight, inertia, moment of inertia and angular momentum of the rotating parts. The resulting forces and torques on the vehicle, which comprise the forces and torques acting at the four wing/fuselage interfaces and at the tail(s)/fuselage interface(s) must be accounted for and used for controlling vehicle attitude and guiding it.

In addition to the control of the thrust of the four thrust generators the control system, which is fundamental for our innovative vehicle, will comprise the control on the tilt angles of the four wings.

As for quadricopter and due to the many degrees of freedom, the pilot, to maneuver the aircraft, does not directly control the various actuators acting on the thrust generators and on the tilt angles but gives inputs, such as aircraft direction and speed, that are implemented by the control system.

During transition from vertical take off to leveled flight the aerodynamic configuration gradually changes by changing, in a controlled way, the tilt angles of the four wings. This allow to maintain the wanted angles of attack for each wing and to exploit the positive lift provided by each wing.

Good aerodynamic efficiency is achieved for cruise by aligning the wings's chords to the flight direction. While all four rotors are used for take off and landing two are more than sufficient for climbing and cruising.

All the wings give positive lift and the control on the tilt angles of each wing provides the desired trim of the aircraft and stability in pitch and in roll. The vertical tail and the control on its mobile surfaces provides directional trim and stability.

The attitude of the fuselage may also be kept at a wanted angle with respect to the local horizontal by controlling adequately the forces and torques at the wing/fuselage interfaces.

In case the thrust generators are propellers or fans they may have feathering or foldable blades in order to reduce the drag of the thrust generators which are not being used during cruise or climb/descent. The use of variable pitch propellers and fans is also possible to improve propulsive effectiveness at the various vehicle speed.

The thrust generators may further be tilted with respect to the wings around axes parallel to the pitch axis in order to adjust their orientation with respect to the wings chords and to achieve the more efficient aerodynamic in any flight phase.

Control of vehicle direction and attitude comprises attitude sensors and air flow sensors for the feedback of the control system and various actuators to vary and control: the tilt angle of each wing, the thrust of each thruster, the orientation of the vertical stabilizer or rudder, the position of the High Lift Device (HLD) of each wing and the tilt angles of the trusters with respect to the wings chords. Attitude sensors comprise accelerometers or Inertial Measurement Units (IMU) and air flow sensors comprises air data probes to sensing airflow speed and direction such as angle of attack and angle of sideslip and they may be installed in front of the wings and in front of the fuselage.

During vertical take off and landing the use of multi phases BLDC electric motors would provide further redundancies in case of failure of one or more phases, or one or more entire electric motor. BLDC motors usually have peak power of about 2.5 times the nominal continuous power and this peak power could be maintained for tens of seconds. The same possibility is valid also for high C rate batteries, wherein, for short discharge periods, it is possible to draw much higher currents than the nominal ones. This would allow, in case of some failures, to increase the currents in the other phases/motors and obtain the overall needed thrust.

Among the advantages provide by this innovative vehicle is the possibility to rapidly rotate each wing at the wanted angles with respect to the airflow direction to exit any possible stall.

### BRIEF DESCRIPTION OF THE DRAWINGS

The invention will be described in the following with reference to not limiting examples provided as explanatory purpose and not limitative of the appended drawings. These drawings show few aspects and embodiments of the present invention and, where appropriate, reference numbers showing structures, components, materials and/or elements similar throughout the different figures are indicated with the same reference number.

FIG. 1A is perspective view of a vertical take-off and landing aircraft constructed and arranged in accordance with the principle of the invention in the “cruise” configuration with the tilting wings in horizontal position for providing horizontal thrust and four feathering blade propellers;

FIG. 1B is perspective view of a vertical take-off and landing aircraft constructed and arranged in accordance with the principle of the invention in the “cruise” configuration with the tilting wings in horizontal position for providing horizontal thrust, two front feathering blades propellers and two rear folding blades propeller (shown in close configuration);

FIGS. 2A, 2B and 2C are respectively a side view, a top view and a front view of a vertical take-off and landing aircraft constructed and arranged in accordance with the principle of the invention in the “take off and landing” configuration with the tilting wings in vertical position for providing vertical thrust and four foldable blades propeller (shown in open configuration);

FIG. 3A is a side view of a vertical take-off and landing aircraft constructed and arranged in accordance with the principle of the invention in the “cruise” configuration with the tilting wings in horizontal position and four foldable blades propeller aft the wings (the two propellers on the front wings are shown in open configuration and the two on the rear wings are shown in close configuration);

FIG. 3B is a top view of a vertical take-off and landing aircraft constructed and arranged in accordance with the principle of the invention in the “cruise” configuration and four foldable blades propeller in front of the wings (the two propellers on the front wings are shown in close configuration and the two on the rear wings are shown in open configuration);

FIGS. 4A, 4B and 4C are respectively a side view, a top view and a front view of a vertical take-off and landing aircraft constructed and arranged in accordance with the principle of the invention with twin tails, the tilting wings in horizontal position and four foldable blades propeller (the two front propellers are shown in open configuration and the two rear in close configuration);

FIGS. 5A, 5B and 5C show side views of a vertical take-off and landing aircraft constructed and arranged in accordance with the principle of the invention in the “transition” configuration with the tilting wings inclined for providing both vertical and horizontal thrusts with the roll axis of the fuselage oriented respectively along the horizontal (5A), at a positive angle of attack (5B) and at a negative able of attack (5C);

FIG. 6 is a side view of foldable blades propeller in open configuration (left) and close configuration (right);

FIG. 7 is a side view of feathering blades, variable pitch, propeller at different pitch angles;

FIG. 8 is a side view of a foldable blades propeller whose axis orientation may be tilted with respect to the wing's chord;

FIG. 9 is a side view of a thrust generators with orthogonal shaft gear reducers;

FIGS. 10A and 10B are perspective views of some elements of wings/fuselage interfaces.

### DETAILED DESCRIPTION OF THE INVENTION

While the invention is susceptible of many modifications and alternative constructions, some preferred embodiments thereof are shown in the drawings and will be described in detail in the following. However, it is to be intended that the present invention is not limited to the shown embodiment, but on the contrary, the invention is intended to cover all the modifications, alternative constructions and equivalents in the scope of the invention as claimed.

The word or phrase “for example”, “etc.”, “or” indicates not exclusive alternatives without limitation, unless otherwise stated. The word “comprises” means “comprises but not limited to”, unless otherwise stated.

The word “aircraft” is intended to comprise any vehicle able to fly.

The word “cruise flight” is intended to refer to substantially horizontal flight of the aircraft, with possible alternating ascending and descending phases obtained only by varying the aircraft lift, for example by acting on the aircraft speed or on the wings profiles or tilt angles.

In general, disclosed herein is a vertical take-off and landing aircraft, which can also take off and land horizontally, that comprises four tilting wings having opposed left and right wings extending from left and right sides, respectively, of a fuselage having opposed leading and trailing extremities. The four tilting wings can rotate of few radians with respect to the fuselage around two axes parallel to the pitch axis. One of this axes will be in front of the center of gravity of the aircraft and the other axis behind the center of gravity. Each of the two front wings may rotate, independently one from the other and in a controlled way, around the front axis and each of the two rear wings may rotate, independently one from the other and in a controlled way, around the rear axis. The rotors are arranged on the wings with their rotation axes in the direction of motion and these rotation axes may further be tilted with respect to the wings around axes parallel to the pitch axis in order to adjust their orientation with respect to the wings chords and achieve the more efficient aerodynamic in any flight phase. The propeller disks extend beyond the wingtips so large parts of the wings are immersed in the propellers wind streams to reduce the possibility of stall at low speed.

The wings may be located with respect to the fuselage as low wing, mid-wing, high wing or parasol wing and they may be rectangular, tapered, swept back or forward, delta or elliptical type. The location of the tilt rotation axes on the wings depends on type of wings chosen, the expected variation of the center of pressure on each wing and the wanted control torques on the tilt angles. The wings may comprise winglets, vortex generators, Leading Edge High Lift Device (LEHLD) and/or Trailing Edge High Lift Device (TEHLD), such as plain flaps, split flaps, slotted flaps, Kruger flaps, leading edge flaps or slots, ailerons or flaperon. On each wing it is installed a thrust generator powered by at least one electric motor. For vertical take-off and landing the four wings with the thrust generators are tilted up and for cruise the four wings with thrust generators are tilted in horizontal position. The empennage for providing stability to the aircraft may be located either on the trailing part of the fuselage or on each of the aft wings. In case of twin vertical tails, they may also be mounted downstream the aft wings thrusters in order to be more efficient at low translation speed.

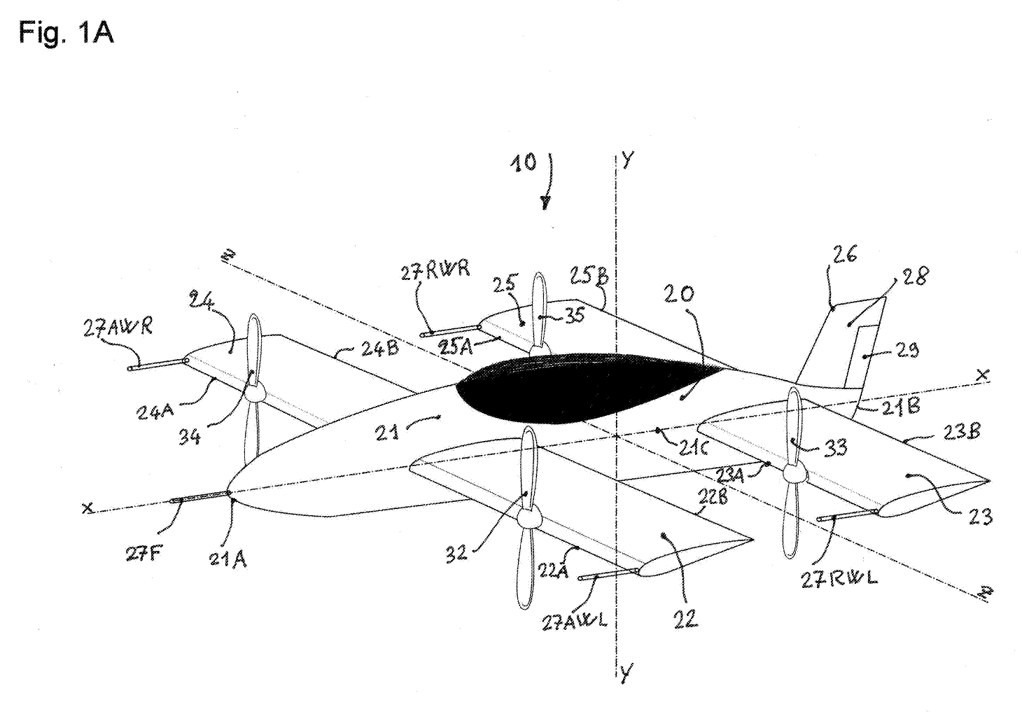

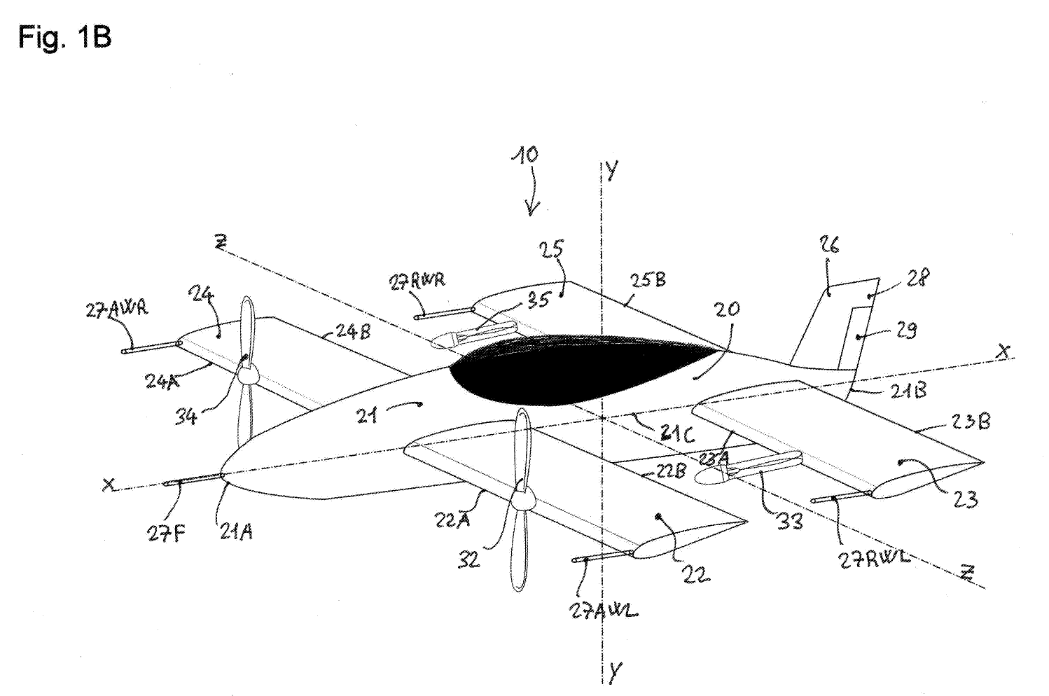

Like reference characters indicate corresponding elements throughout the several figures. FIG. 1A is a perspective view of a vertical take-off and landing (“VTOL”) aircraft 10 comprising an airframe 20 consisting generally of a fuselage 21, left wings 22 and 23, right wings 24 and 25, tail empennage 26. Left and right wings 22, 23, 24 and 25 are mounted on the fuselage 21 with tilting mechanism which allow them to rotate around axes parallel to the pitch axis Z, and so airframe 20 is exemplary of a tilted wing airframe in accordance with the invention. Fuselage 21 has front end 21A and an opposed rear end 21B, opposed left and right sides 21C and 21D (not shown). On the wings 22, 23, 24 and 25 are installed thrust generators 32, 33, 34 and 35. Left wings 22 and 23 and right wings 24 and 25 are airfoils that produce lift for flight of aircraft 10 through the atmosphere. Wings 22, 23, 24 and 25 have respectively leading edges 22A, 23A, 24A and 25A and trailing edges 22B, 23B, 24B and 25B.

On the leading extremity 21A of the fuselage and/or at some of all the leading edge 22A, 23A, 24A and 25A of the wings it may be installed air data flow sensors 27F, 27AWL, 27RWL, 27AWR and 27RWR respectively such as air probes and Pitot tubes.

Empennage 26 may comprise a vertical stabilizer 28 and a rudder 29 pivotally retained on the stabilizer 28. Alternatively the entire empennage 26 may rotate, in a controlled way, with respect to the fuselage 21 around an axis orthogonal to the pitch axis Z.

In the embodiment shown in FIG. 1A the thrust generators 32, 33, 34 and 35 may comprise feathering variable pitch propellers.

In the embodiment shown in the FIG. 1B the front wings thrust generators 32 and 34 comprise feathering blades, variable pitch propellers and the rear wings thrust generators 33 and 35 comprise foldable blades propellers.

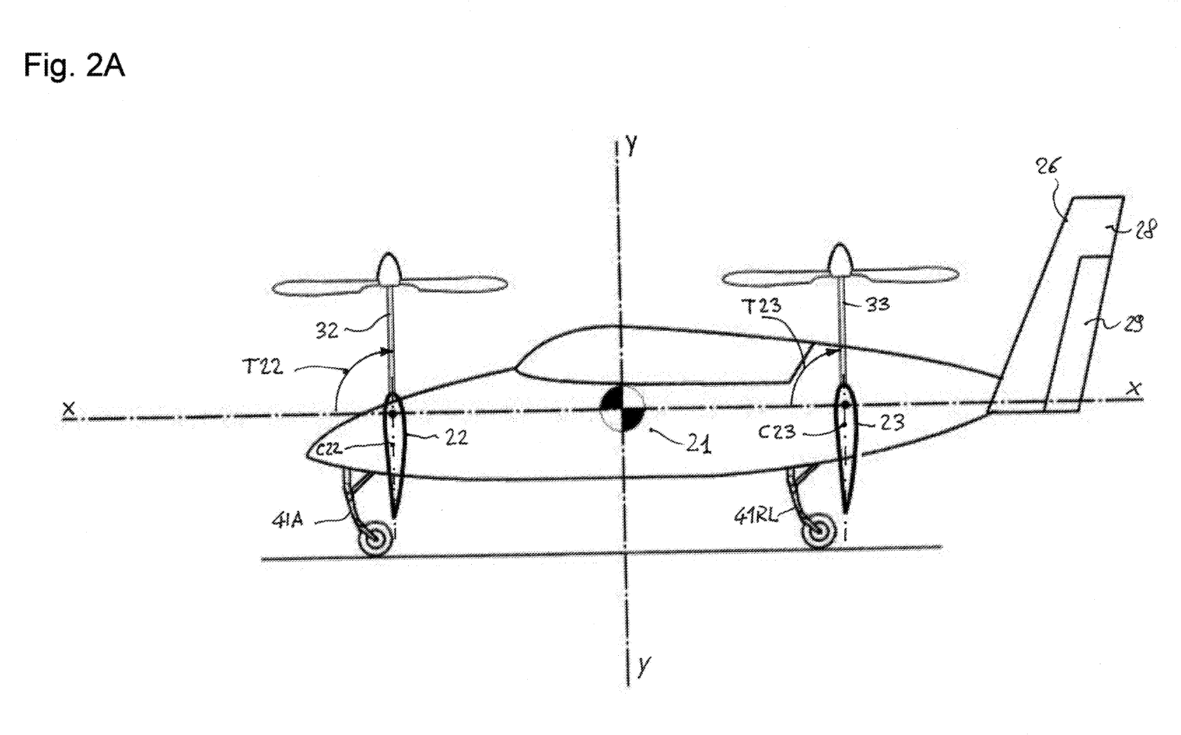

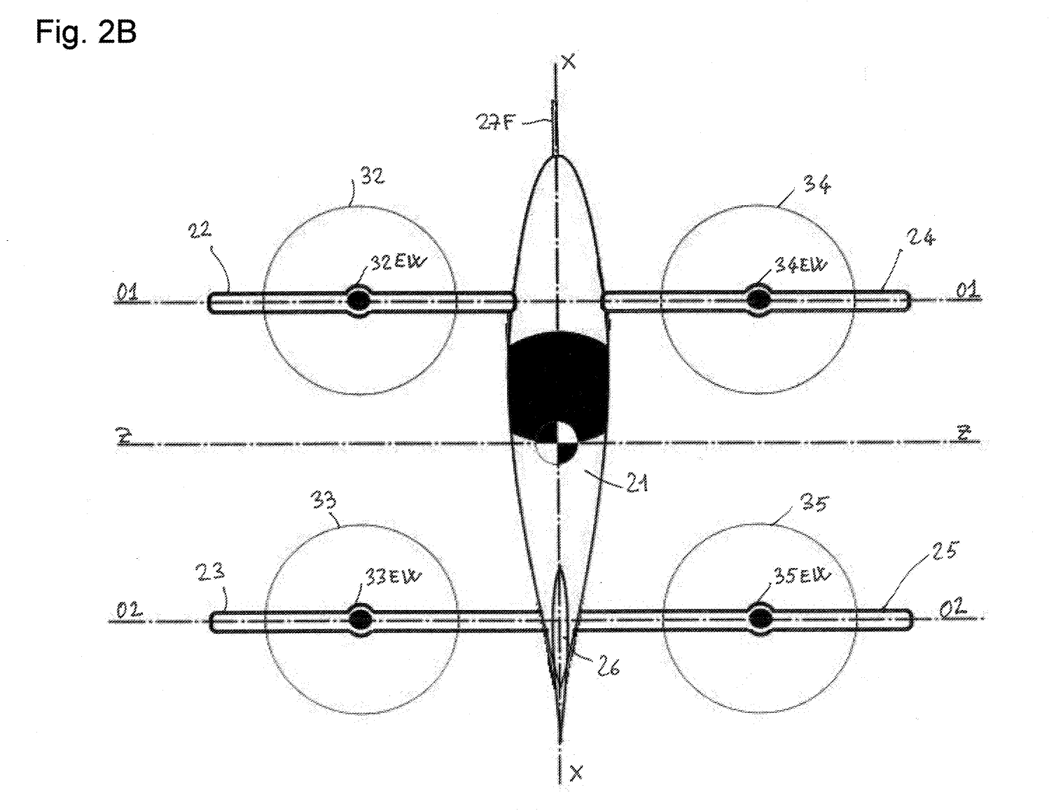

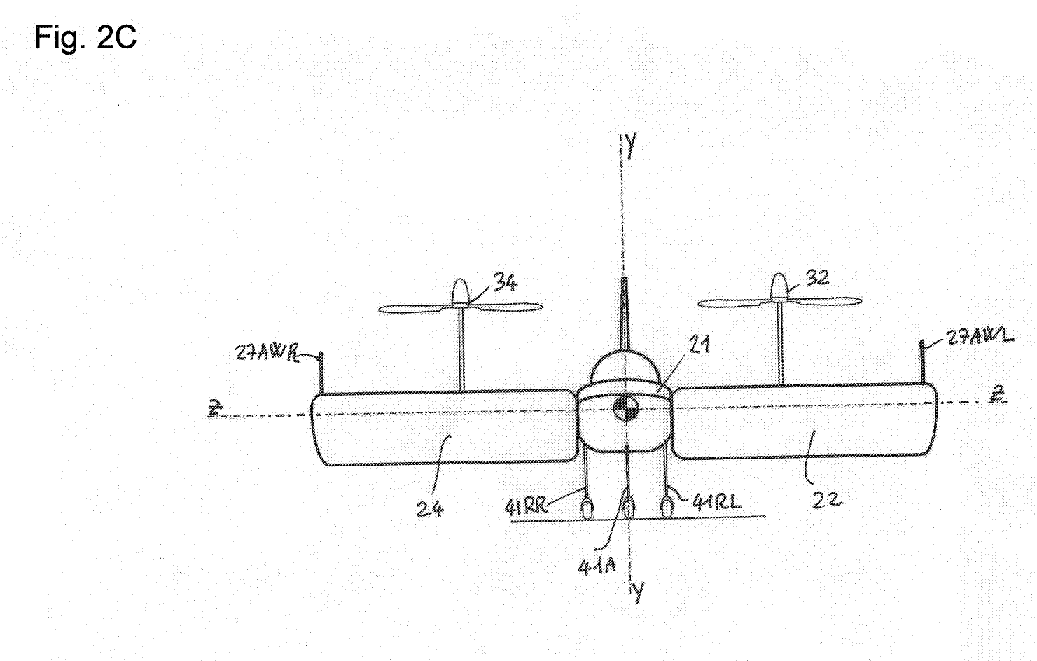

FIG. 2A shows a side view of the VTOL aircraft with the wings in mid-wing location and wings chords C22 and C23 oriented along the vertical with tilt angles T22 and T23 at about +90° with respect to the roll axis X. In this embodiment the thrust generators comprises foldable blades propellers 32 and 33 shown in open configuration. When the air flows on the wings produce significant aerodynamic forces, the tilt angles T22, T23, T24 and T25 will be reduced in order to maintain the resulting forces along the vertical or along the wanted direction. FIG. 2B shows a top view of the VTOL aircraft according to the invention. As indicated in this figure in the area of thrusters installation 32EW, 33EW, 34EW and 35EW the airfoil profiles may have a larger section to accommodate electric motor and other thruster components. Wings 22 and 24 may rotate, independently one from the other, around the aft tilting axis 01 and the wings 23 and 25 may rotate, independently one from the other, around the rear tilting axis 02. Location of intersections of these axes with the fuselage 21 will depend on the weight distribution and the wing location chosen (mid-wing in the case of the FIG. 2). It would be also possible to have one axis in a vertical position, such as mid-wing and the other axis in a different vertical position, such as low wing or high wing. Since the aircraft may take off and land vertically or horizontally, FIGS. 2A and 2C show also landing gear elements 41A, 41RL and 41RR which are usable also for horizontal take off and landing.

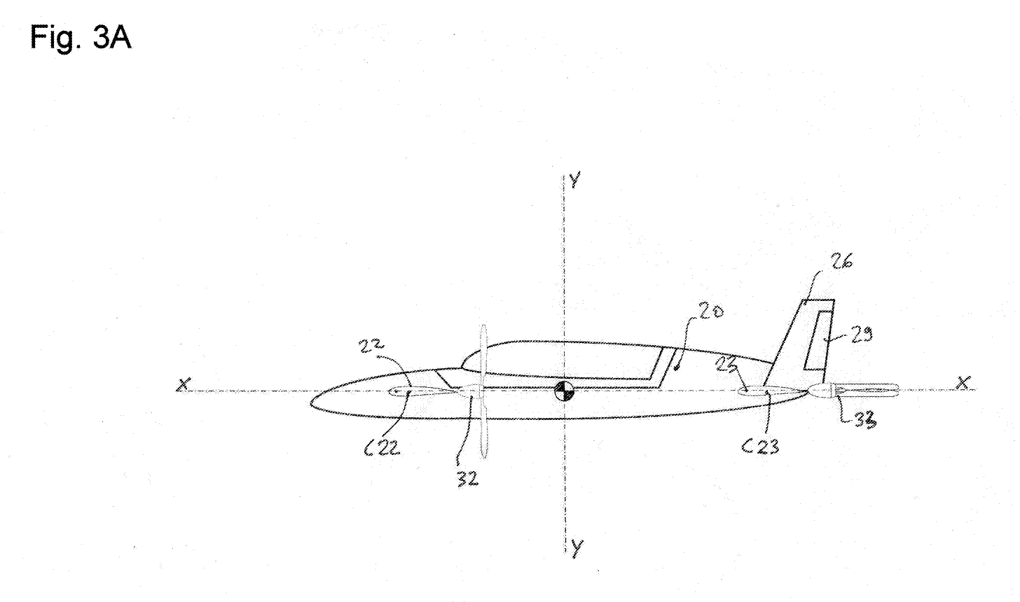

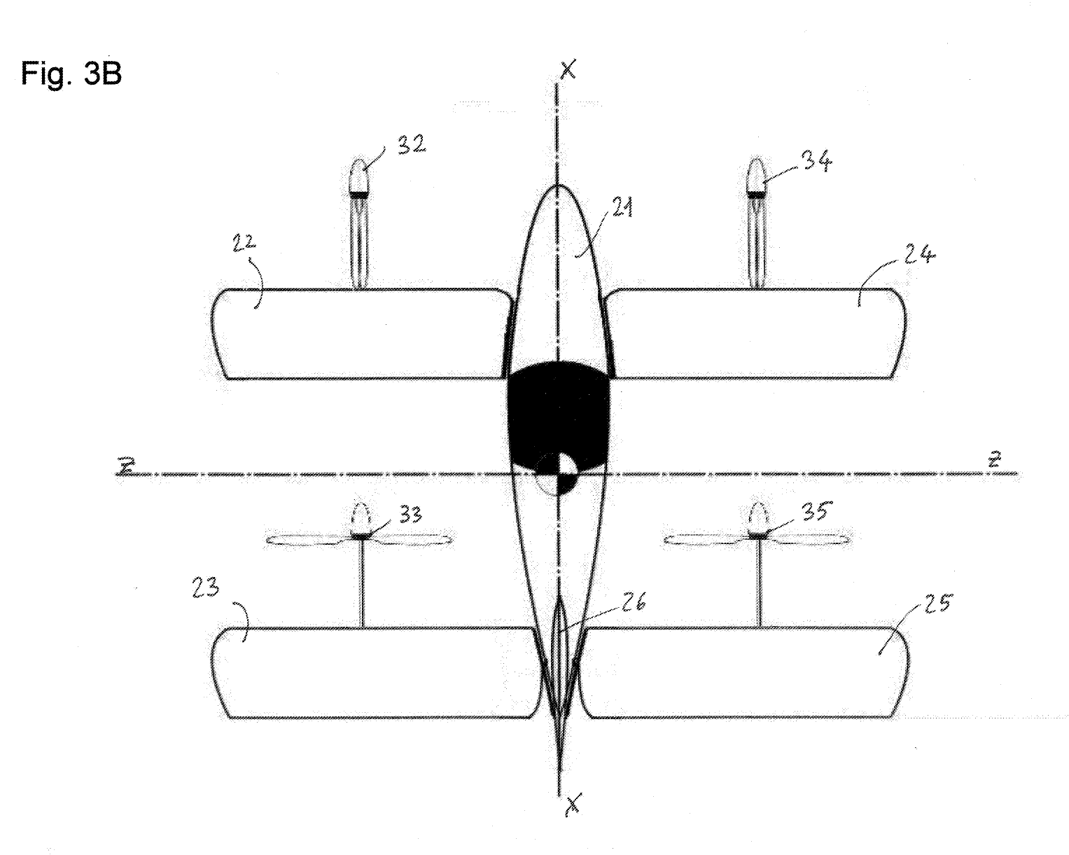

The thrust generators may be located in front of the wings, as indicated in the FIGS. 1 and 2 or aft the wings, as indicated in FIG. 3A, or both in front and aft the wings depending on the configuration chosen. In the side view of FIG. 3A the aircraft is shown in the cruise configuration with wings chords C22 and C23 aligned along the direction of motion, with the left thrust generator 32 open to provide thrust (right thrust generator 34 is not shown in the view) and the left thrust generator 33 close to reduce drag (right thrust generator 35 is not shown in the view). In the top view of FIG. 3B the aircraft is shown in the cruise configuration with the aft thrust generator 32 and 34 closed to reduce drag and the rear thrust generators 33 and 35 open to provide thrust.

It may also be chosen a thrust generators configuration with some thrust generators in front of the wings and some aft of the wings. It may also be chosen a configuration with only two wings with thrust generators locate both in front and aft these wings and the other two thrust generators located either in front of the other two wings or aft to them.

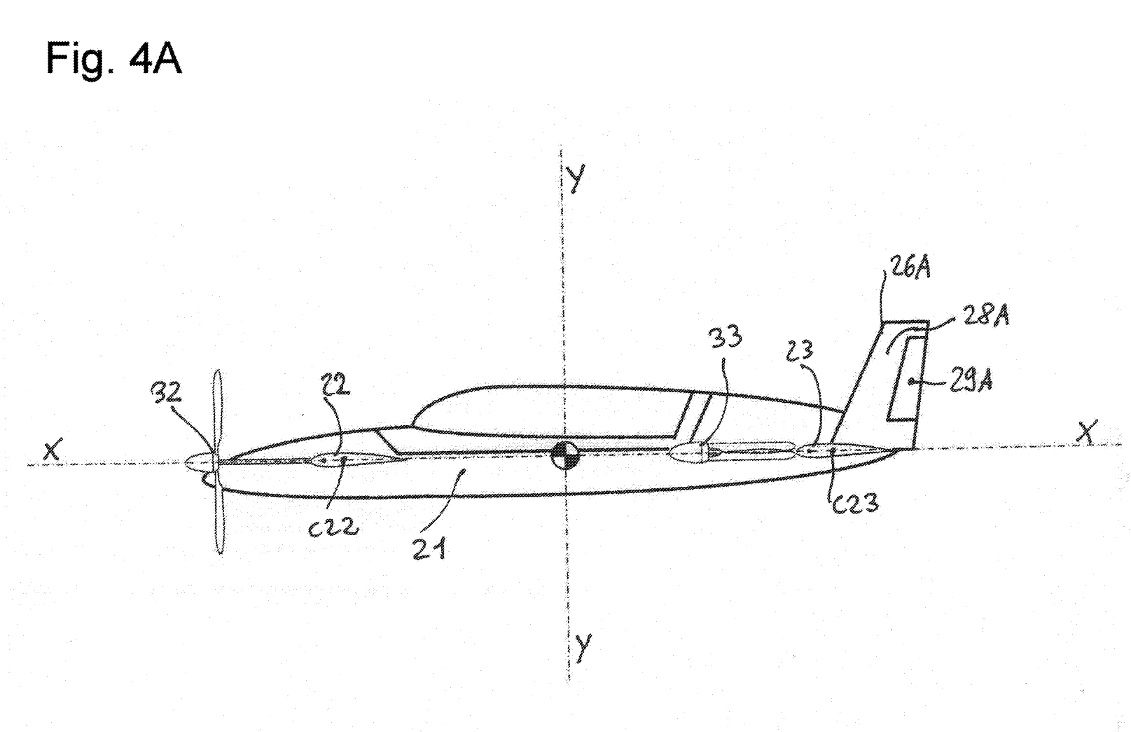

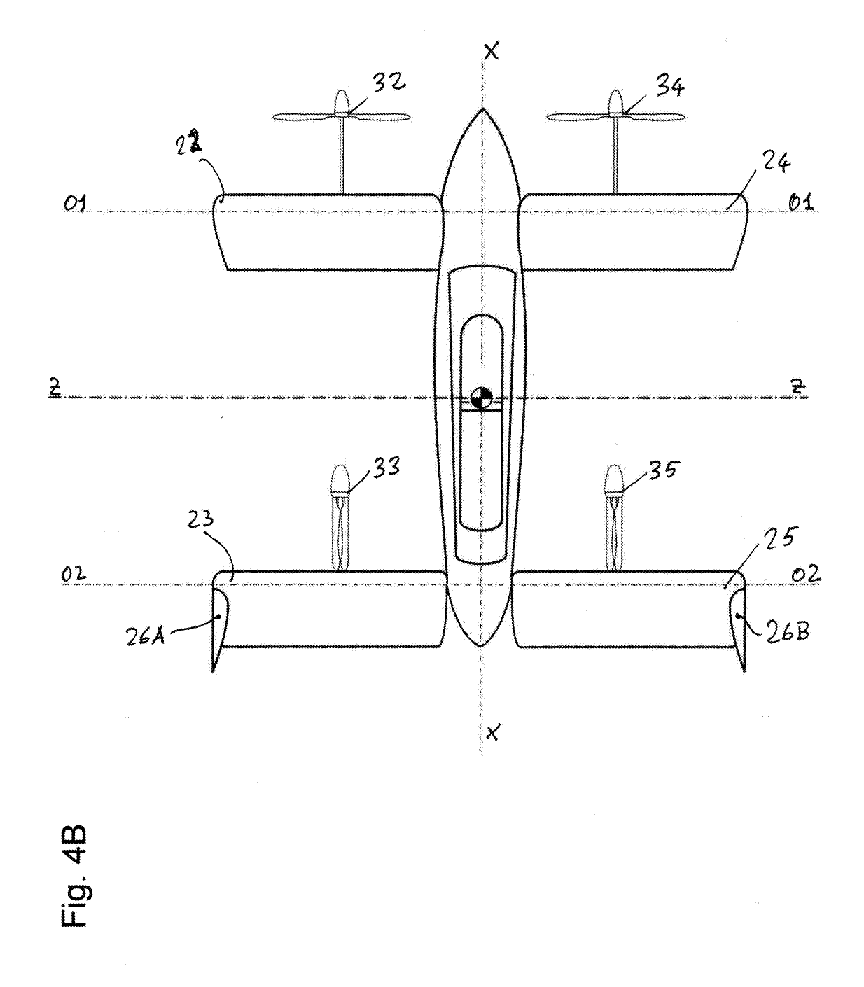

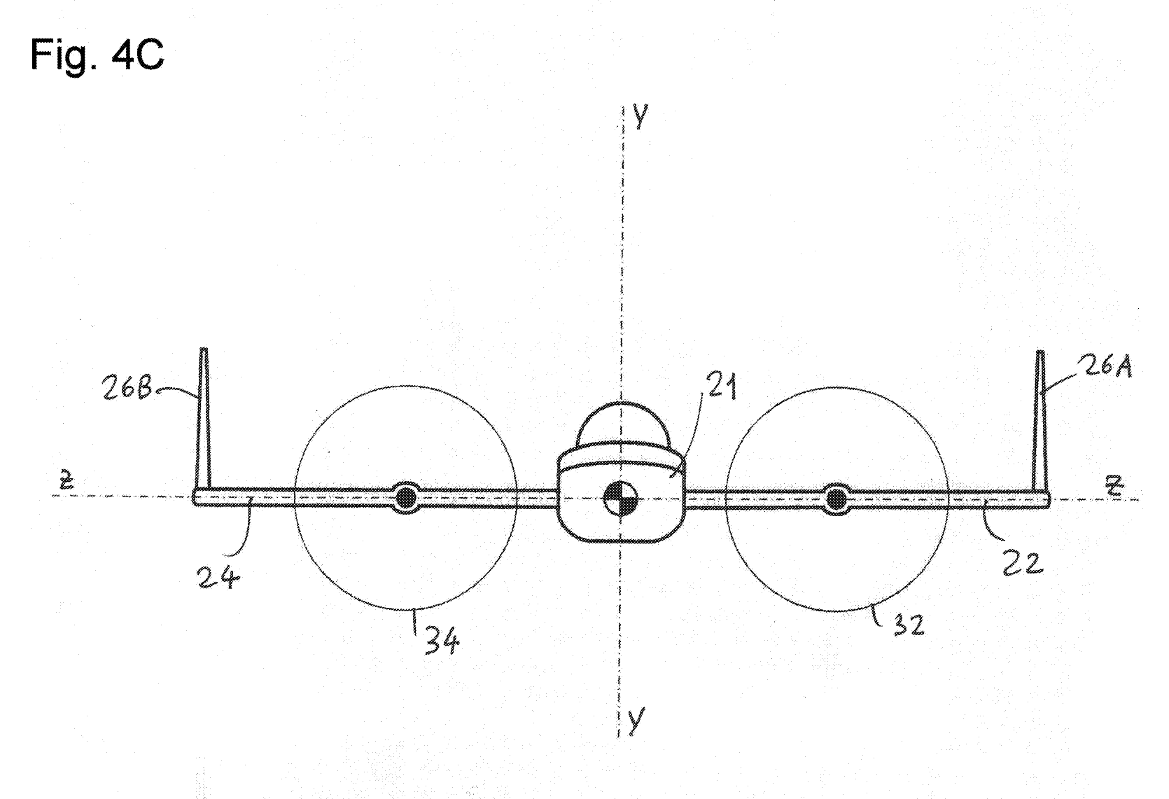

FIGS. 4A, 4B and 4C show respectively a side view, a top view and a front view of the VTOL aircraft with twin tails in cruise configuration with the wings in mid-wing location and wings chords C22 and C23 oriented along the horizontal. In this embodiment thrust generators comprises foldable propellers 32, 33, 34 and 35. Thrust generators 32 and 34 are shown in open configuration to provide thrusts along the horizontal to propel the aircraft 20 and thrust generators 33 and 35 are shown in close configuration to reduce drag. FIG. 4B shows a top view of the VTOL aircraft according to the invention. Wings 22 and 24 may rotate, independently one from the other, around the aft tilting axis 01 and the wings 23 and 25 may rotate, independently one from the other, around the rear tilting axis 02. Each twin tail 26A and 26B may comprise a vertical stabilizer 28A and a rudder 29A pivotally retained on the stabilizer 28A.

Alternatively the entire empennages 26A and 26B may rotate, in a controlled way, with respect to the wings 23 and 25 around axes orthogonal to the axis 02.

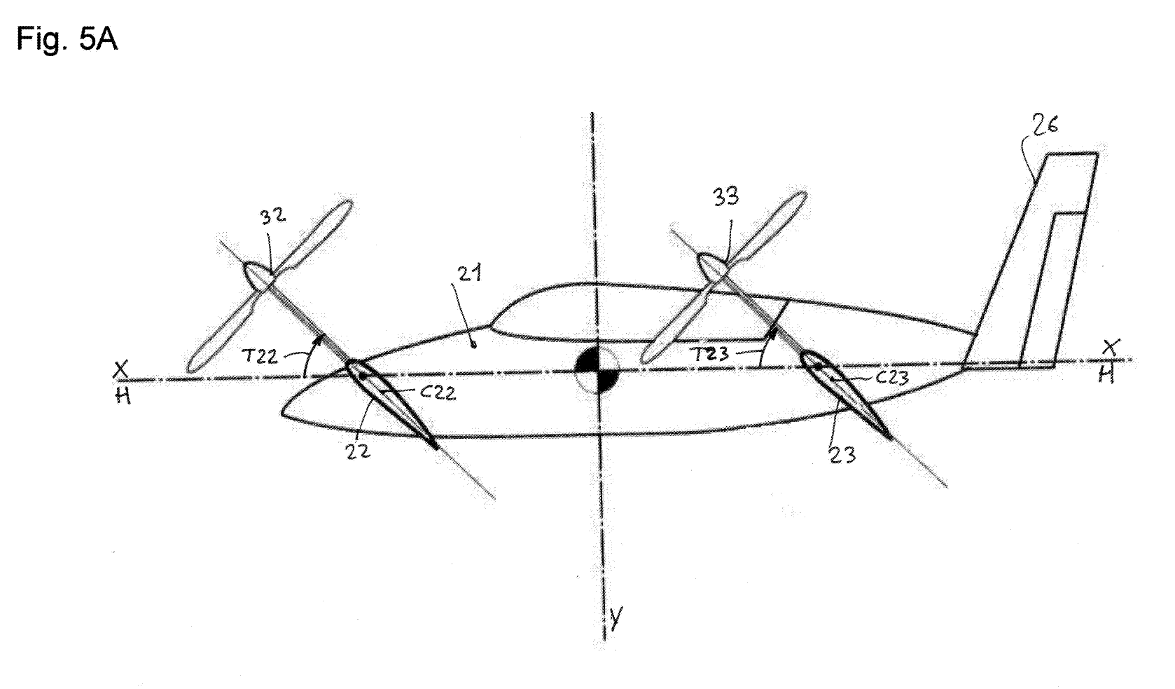

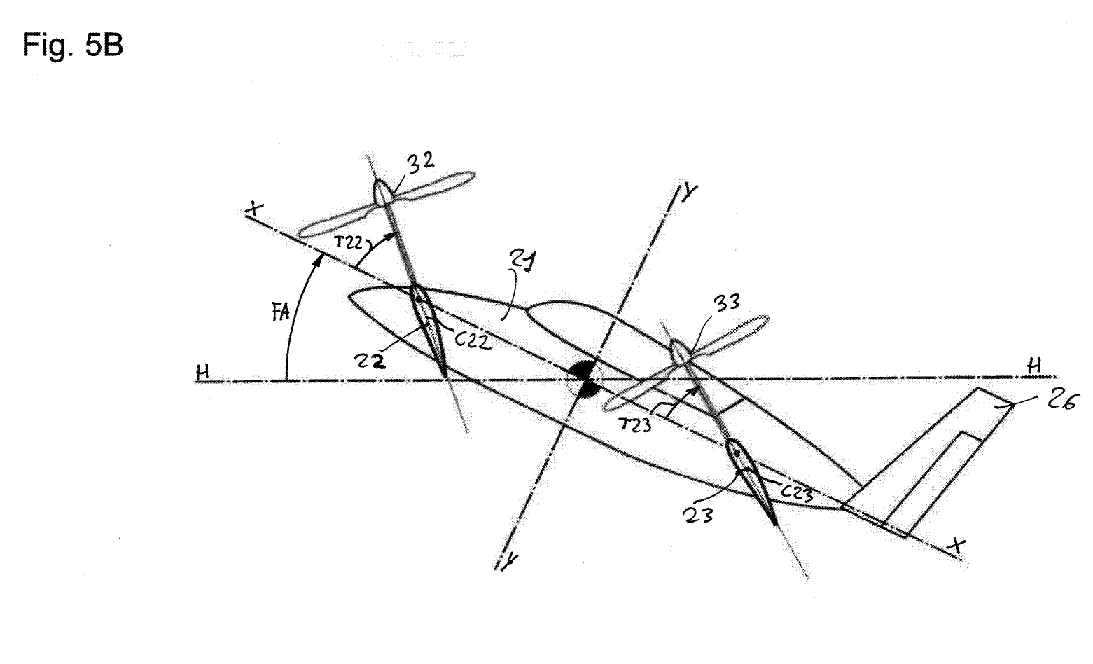

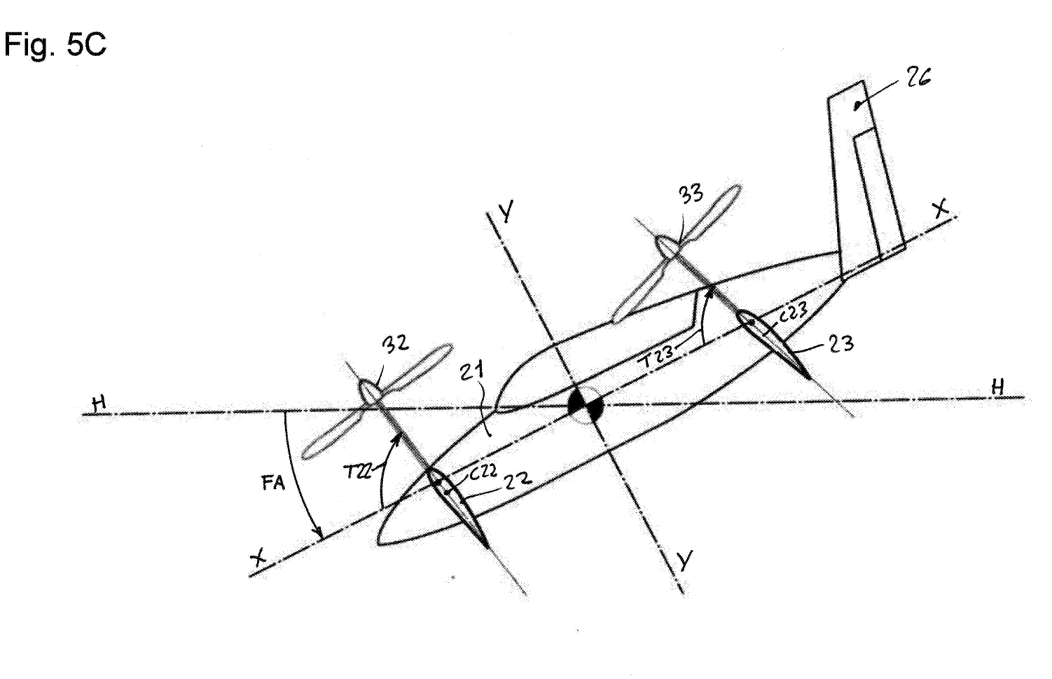

FIG. 5A shows a side view of the VTOL aircraft according to the invention in transition configuration with the wings in mid-wing location and wings chords C22 and C23 tilted at angles T22 an T23 with respect to roll axis which, in this case, is parallel to the local horizontal H. Tilt angle T22 may be different from tilt angle T23. The fuselage also is shown with its roll axis X oriented along the horizontal H. However different attitude of the fuselage with respect to the horizontal may be achieved and maintained in a controlled way by controlling the thrusts of the thrust generators and the tilt angles of the wings.

FIG. 5B shows a side view of the VTOL aircraft according to the invention in transition configuration with the wings in mid-wing location and wings chords C22 an C23 oriented with tilt angles T22 and T23 with respect to fuselage roll axis X. The fuselage roll axis X is shown inclined of a positive angle FA with respect to the local horizontal H.

FIG. 5C shows a side view of the VTOL aircraft according to the invention in transition configuration with the wings in mid-wing location and wings chords C22 and C23 oriented with tilt angles T22 and T23 with respect to fuselage roll axis X. The fuselage roll axis X is shown inclined of a negative angle FA with respect to the local horizontal H.

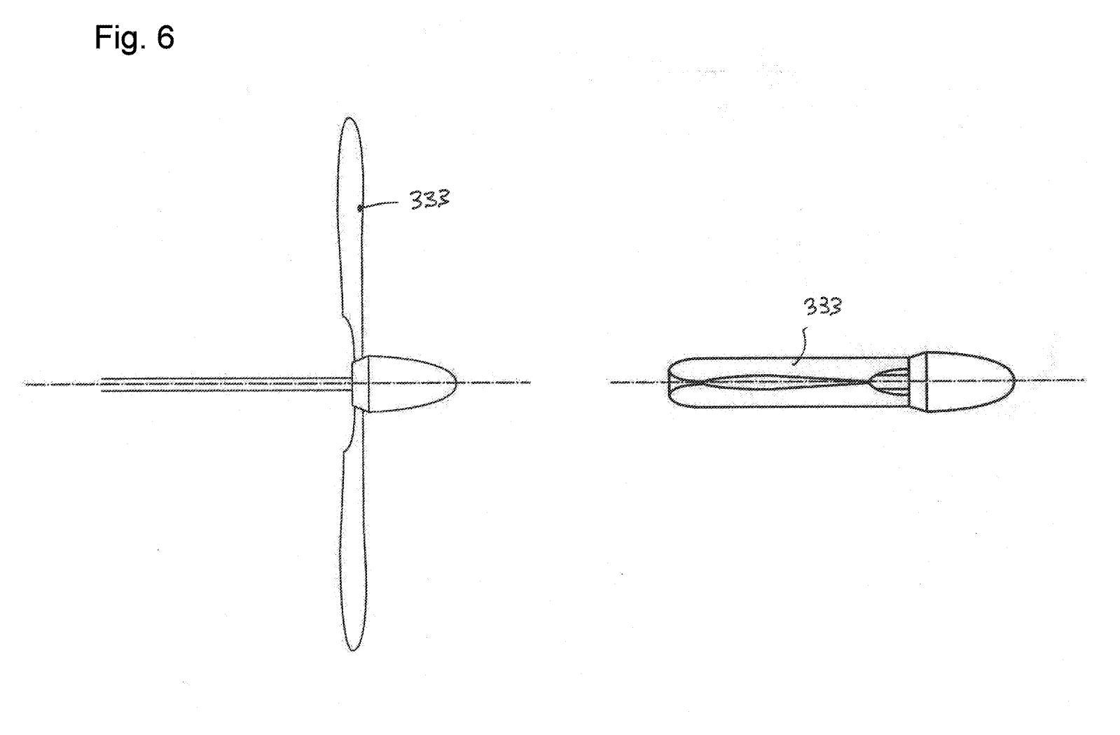

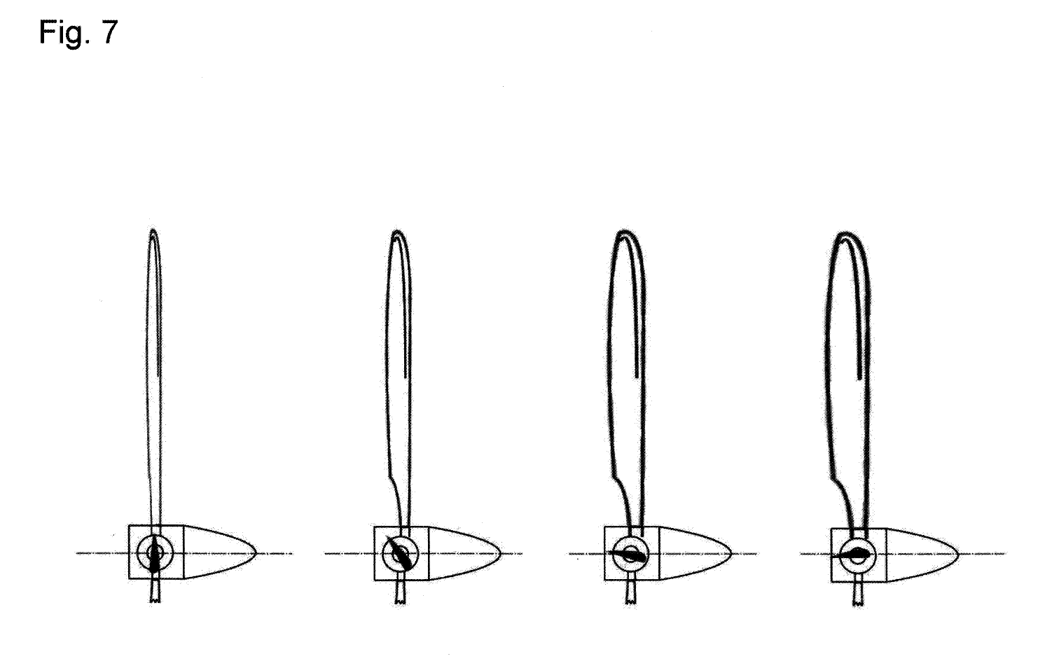

In case the thrust generators are propellers or fans they may have foldable blades or feathering blades in order to reduce the drag of the thrust generators which are not being used during cruise or climb/descent. FIG. 6 shows a foldable blades propeller; on the left side of the FIG. the blades 333 are shown open and on the right side of the figure they are shown closed. FIG. 7 shows a feathering, variable pitch propeller with the blades at different angles of orientation. In all cases the number of blades of the propellers can be higher than two.

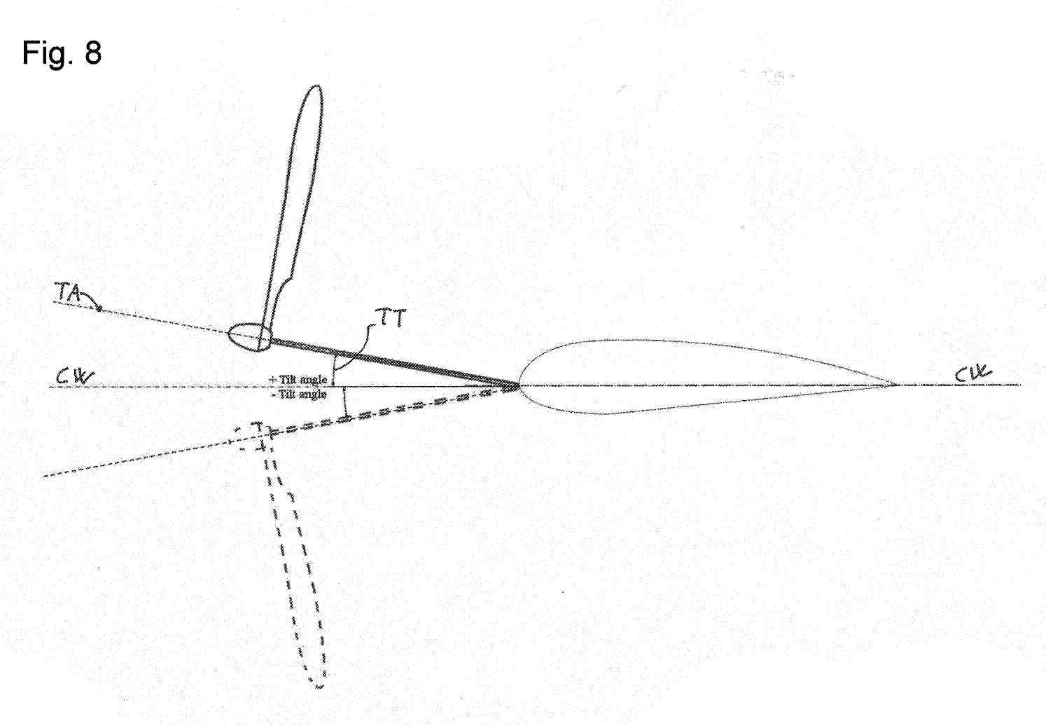

In all the cases, as shown in FIG. 8, the thrust generators axis TA may further be tilted, around axes parallel to the pitch axis Z, at an angle TT with respect to the wings chords CW in order to adjust thrusters air flow direction with respect to the airfoil and achieve the more efficient aerodynamic in any flight phase.

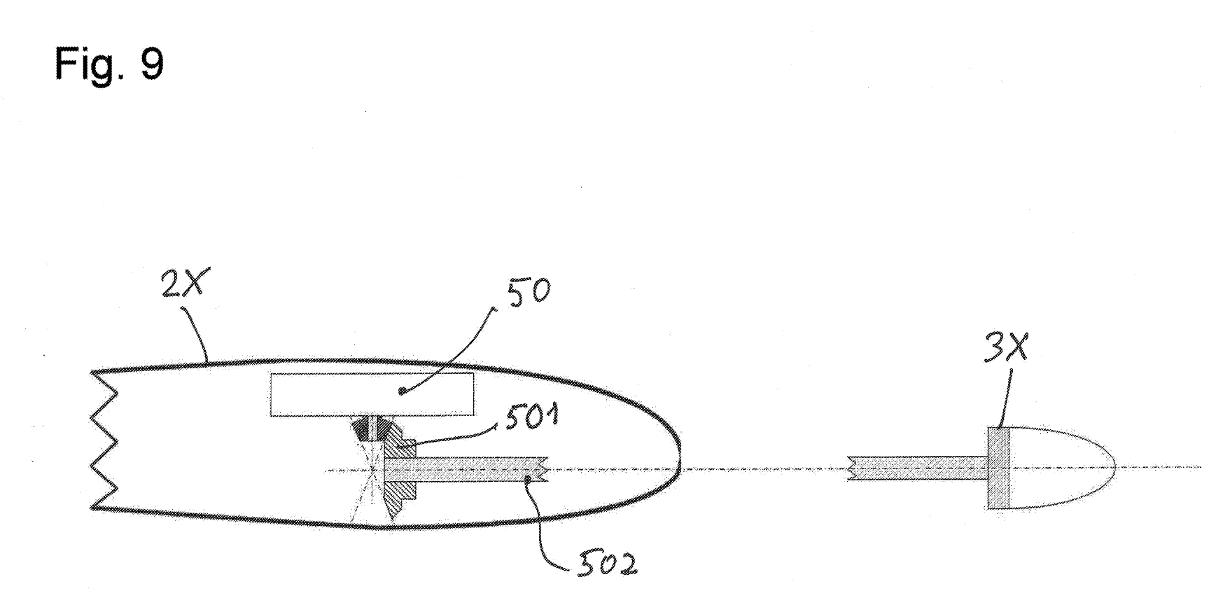

The thrust generators are driven by electric motors 50 which may be installed inside the wings 2X and they may be mounted with their rotation axes parallel to the rotor axis 502 or, as shown in the FIG. 9, they may be mounted with their rotation axes perpendicular to the rotor axis 502 and use orthogonal shaft gear reducers 501 which may allow a reduced frontal section of the electrical motor as well as the use of higher rpm motor.

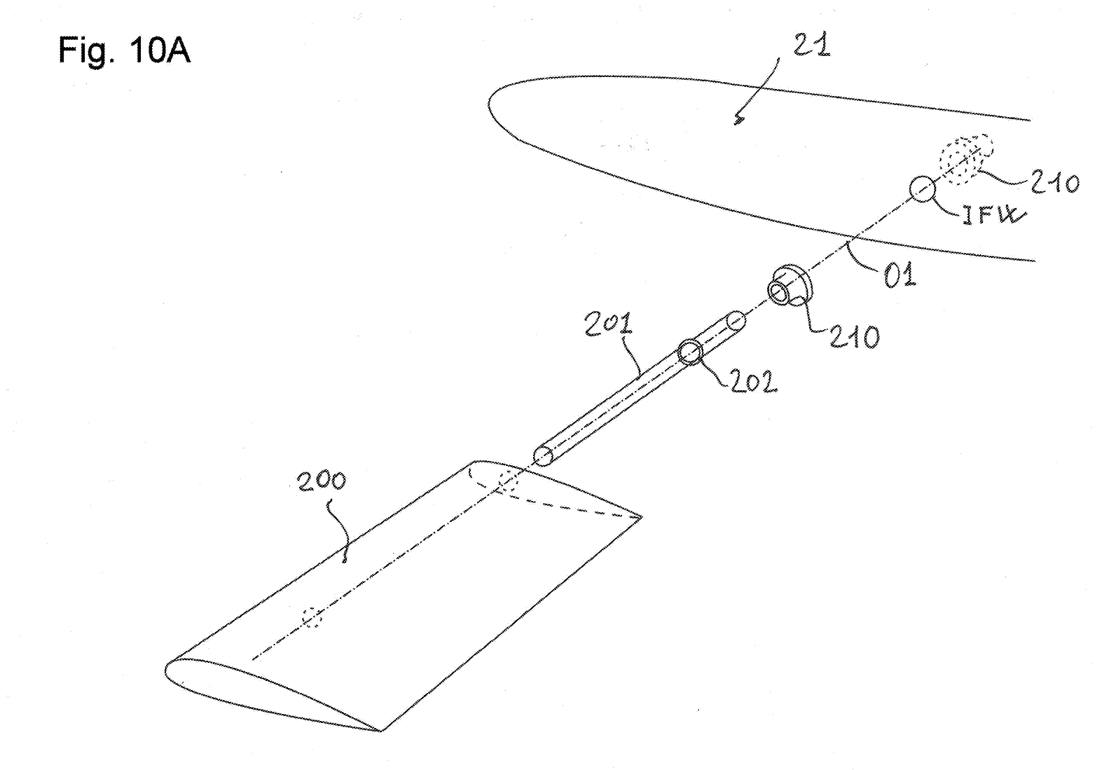

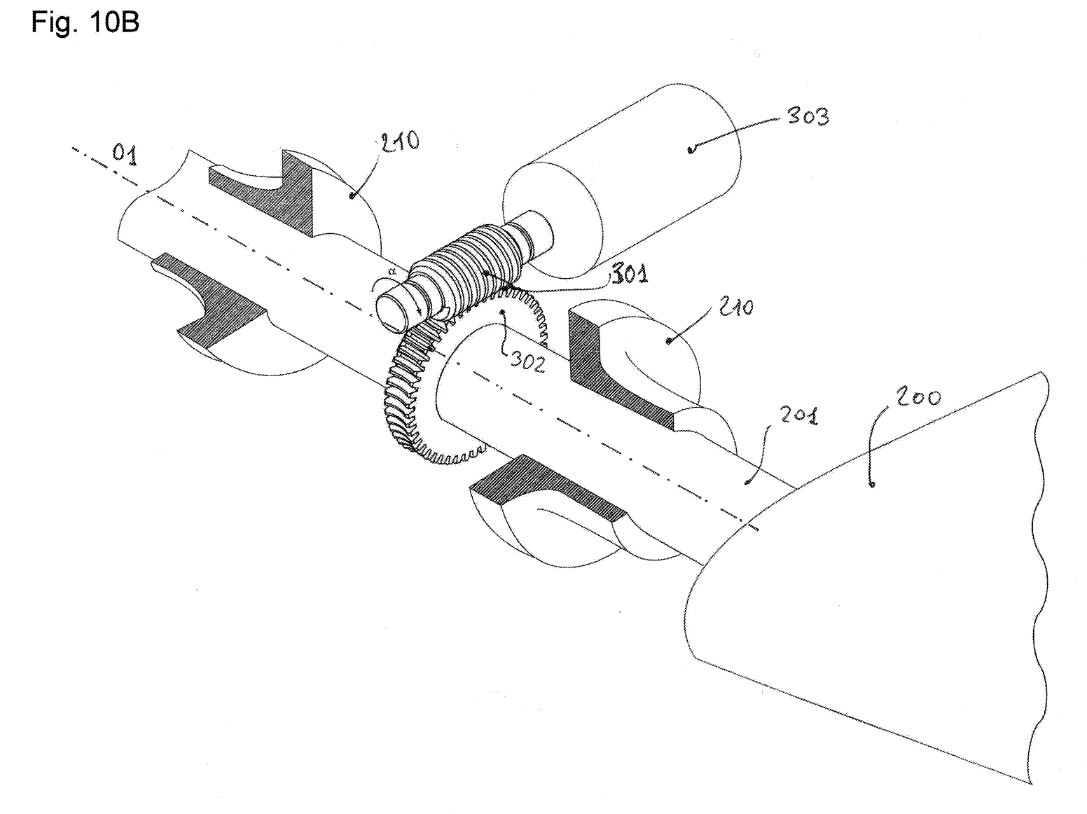

FIG. 10A shows an exploded view of some elements of the wing/fuselage interface IFW. Each wing comprises an airfoil 200 which is structurally fixed to a beam 201 rotational that can rotate with respect to the fuselage 21, around axes 01 parallel to the pitch axis, through one or more rotational interfaces 210, structural fixed to the fuselage 21 and which transfer to the fuselage 21 the forces and torques generated by the thrusts of the thrust generators 32, 33, 34 and 35 and aerodynamic and inertial forces acting on the wings 22, 23, 24 and 25. In the figure is also indicated a flange 202 structurally fixed to the beam 201 which may be used with the Tilting mechanism. Tilting mechanisms to control the torques for the rotation of the wings around these axes 01 and 02, parallel to pitch axis Z, may comprise the commonly used mechanism for the movement and control of the aircraft movable control surfaces or, for example, worm gear or ball worm gear transmissions as shown in FIG. 10B. FIG. 10B is perspective view of an example of worm gear transmission. An airfoil 200, structurally fixed to a beam 201 which may rotate around an axis 01 through rotational interfaces 210 which are structurally fixed to the fuselage 21. A worm gear 302, fixed to the beam 201, may be put into rotation by a rotation alfa of the worm 301 through an actuator 303 such as an electrical motor which is fixed to the structure of the fuselage 21. Choice of the tilting mechanism depends also on the magnitude of the needed control torques.

1. An aircraft, comprising:
a fuselage,
vertical tail
at least one electric generator which uses liquid fuel,
four wings,
rechargeable electric energy storage devices,
fuel tank,
sensors comprising air flow sensors and
an actuation and feedback control system;
wherein there is at least one electric motor in each wing which drives at least one thrust generator,
wherein the thrust generators may provide a combined thrust higher than the aircraft weight,
wherein the thrust generators wind streams interact with all the vehicle wings during vertical take off and landing,
wherein the power required to drive the electric motors comes from at least one electric generator and wherein the additional power required to provide a thrust higher than the aircraft weight comes from rechargeable electric energy storage devices,
wherein the four wings are tilting wings that can rotate, independently one from the other, around two axes parallel to the pitch axis,
wherein one of these axis is in front of the center of gravity of the aircraft and the other axis is behind the center of gravity
wherein all the four wings provide positive lift during forward flight and
wherein the actuation and feedback control system comprises means to regulate the rotational speed of each thrust generator and the tilt angle of each wing with respect to the fuselage according to the commands provided, where these commands comprise the aircraft direction and speed.

2. Aircraft according to claim 1, wherein said thrust generators comprise propellers or fans with foldable or feathering blades.

3. Aircraft according to claims 1 and 2, wherein said thrust generators comprises variable pitch propellers or fans.

4. Aircraft according to one of the previous claims wherein the front wings have different size than the other two wings.

5. Aircraft according to one of the previous claims wherein some or all wings comprise winglets, vortex generators and/or High Lift Devices (HLD).

6. Aircraft according to one of the previous claims in which there may be two or more vertical tail and these may also be mounted on the aft wings.

7. Aircraft according to one of the previous claims wherein the thrust generators may further be tilted with respect to the wings around axes parallel to the pitch axis.

8. Aircraft according to one of the previous claims in which the two front wings can rotate together and the two rear wings may rotate together.

9. Method for vertical take-off and transition to the cruise flight of an aircraft comprising the characteristics of any one of claims 1 to 8, comprising the steps of:
a. recharging the energy storage devices at ground;
b. activation of the control system;
c. flight management by the pilot through the control system that:
1. acquires the flight inputs supplied from time to time by the pilot;
2. adjusts the tilt angles of the wings and the powers supplied to the thrust generators; according to the existing flight parameters and the flight inputs indicated by the pilot;
3. once the aircraft reached the wanted height, gradually varies the tilt angles of the wings to increase the horizontal component of thrust and varies the thrust produced by each thrust generator to accelerate the aircraft horizontally until reaching the necessary speed to aerodynamic sustenance by means of the four wings;
4. deactivates the unnecessary motors for the cruise and orients the blades of the not used thrust generators to reduce the aerodynamic resistance;
5. allows the continuation of the flight using only the needed thrust generators by using the electricity generated by the electric generator;
d. recharging the storage devices deriving energy from the electric generator;
